(19) United States
(12) Patent Application Publication
(10) Pub. No.: US 2025/0019469 A1
(43) Pub. Date: Jan. 16, 2025

(54) SOLUTION PROCESS FOR PRODUCTION OF FUNCTIONALIZED POLYOLEFINS

(71) Applicant: SABIC GLOBAL TECHNOLOGIES B.V., BERGEN OP ZOOM (NL)

(72) Inventors: Miloud Bouyahyi, Eindhoven (NL); Nicolaas Hendrika Friederichs, Brunssum (NL); Robbert Duchateau, Roostenlaan (NL); Lidia Jasinska-Walc, Veldhoven (NL)

(21) Appl. No.: 18/709,918

(22) PCT Filed: Nov. 14, 2022
(86) PCT No.: PCT/EP2022/081858

§ 371 Date: May 14, 2024

(30) Foreign Application Priority Data
Nov. 22, 2021 (EP) 21209621.8

(51) Int. Cl. C08F 2/06; C08F 4/659; C08F 8/12; C08F 210/02; C08F 210/06; C08F 210/14; C08F 216/08

(52) U.S. Cl. CPC C08F 2/06; C08F 4/65912; C08F 8/12; C08F 210/02; C08F 210/06; C08F 210/14; C08F 216/08

(57) ABSTRACT

The present invention relates to a process for solution copolymerization process to produce a functionalized polyolefin using a catalyst system comprising a hafnium or zirconium or titanium complex supported by a dianionic tri- and/or tetra-dentate ligand and a co-catalyst selected from the group: MAO, MMAO, DMAO, SMAO or ammonium salts or trityl salts of fluorinated tetraarylborates.

### TECHNICAL FIELD OF THE INVENTION

The present invention relates to a process to obtain functionalized polyolefin, in particular hydroxyl functionalized, in a solution process, and its functionalized polyolefin.

### TECHNOLOGICAL BACKGROUND OF THE INVENTION

Functionalized polyolefins are known in the art.

For example, EP3034545 discloses a process for the preparation of a graft copolymer comprising a polyolefin main chain and one or multiple polymer side chains, the process comprising the steps of:
A. copolymerizing at least one first type of olefin monomer and at least one second type of metal-pacified functionalized olefin monomer using a catalyst system to obtain a polyolefin main chain having one or multiple metal-pacified functionalized short chain branches, the catalyst system comprising:
   1. a metal catalyst or metal catalyst precursor comprising a metal from Group 3-10 of the IUPAC Periodic Table of elements;
   2. optionally a co-catalyst;
B. reacting the polyolefin main chain having one or multiple metal-pacified functionalized short chain branches obtained in step A) with at least one metal substituting agent to obtain a polyolefin main chain having one or multiple functionalized short chain branches;
C. forming one or multiple polymer side chains on the polyolefin main chain, wherein as initiators the functionalized short chain branches on the polyolefin main chain obtained in step B) are used to obtain the graft copolymer.

However, such process is generally performed under slurry condition which has important drawbacks:
The need of a specific catalyst in order to incorporate functional comonomer in high degree;
The solid content must be <15 wt % especially when a homogeneous catalyst is used, otherwise statics become a severe problem giving gels that retain a lot of diluent.
Reactor fouling occurring when using homogeneous single-site catalysts at temperatures below the crystallization temperature of the polymer being formed;
Precipitated polymer retains a large fraction of unreacted functional comonomer;
Deprotection is difficult once polymer has precipitated.

However, this process can also be realized under solution conditions. However the following drawback appears:
Catalysts are not thermally stable, leading to low catalyst yields;
Only low MW polymers are produced with low isotacticity for the polypropylenes.

Therefore, there is a need for a process to produce functionalized polyolefins that overcome at least one of these drawbacks.

### SUMMARY

This object is achieved by the present invention. Accordingly, the present invention relates to a process for solution copolymerization to obtain a functionalized polyolefin comprising at least the following steps:
a) A copolymerization step of at least one olefin monomer and at least one protected functionalized olefin monomer in the presence of a catalyst system, wherein the olefin monomer is represented by CHR¹=CHR², wherein R¹ and R² are each independently chosen from hydrogen or a hydrocarbyl group having 1 to 6 carbon atoms, wherein the protected functionalized olefin monomer is a reaction product of a functionalized olefin monomer and a protecting agent during a protection step and the functionalized olefin monomer represented by the structure according to Formula (I):

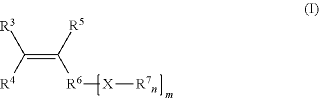

wherein R³, R⁴, and R⁵ are each independently selected from the group consisting of H and hydrocarbyl with 1 to 16 carbon atoms,
wherein R⁶—[X—(R⁷)ₙ]ₘ is a polar functional group containing m heteroatom-containing functionalities X—(R⁷)ₙ, in which m is an entire number between 1 and 10, preferably 1 or 2, wherein
   when n=1, X is selected from —O—, —S— or —CO₂— and R⁷ is H,
      or
   when n=2, X is N and at least one R⁷ is H and the other R⁷ is selected from the group consisting of H and a hydrocarbyl group with 1 to 16 carbon atoms,
wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms and R⁶ comprises 1 to 10 carbon atoms,
wherein X is attached to either the main chain and/or side chain of R⁶,
wherein R⁴ and R⁶ may together form a ring structure that is functionalized with one or multiple X—(R⁷)ₙ,
   and wherein the catalyst system comprises:
      metal- bis-phenolate based ligand complexes used in this invention can be characterized by the general formula:

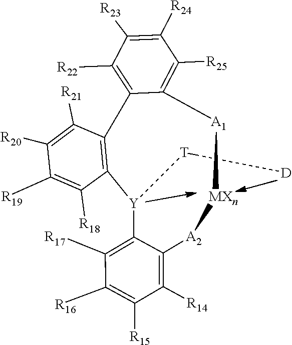

Wherein
   each of R₁₄ to R₂₅ may individually be a moiety selected from hydrogen, an aryl 5 moiety, an aryl moiety, a halogen, an alkyl or aryl moiety with halogen substituent(s), an alkoxy moiety, a siloxy moiety, or a nitrogen-containing moiety, wherein each R moiety may optionally form a ring structure with an adjacent R moiety;
   each of A₁ and A₂ may individually be a moiety selected from:
      an element of Group 16 of the periodic system; and
      a moiety containing an element of Group 15 of the periodic system;
   preferably wherein A₁ and A₂ are selected from O or NR₂₆, wherein R₂₆ is an alkyl, aryl or arylalkyl moiety, preferably a substituted or unsubstituted phenyl moiety, preferably a p-tolyl moiety
   T is a divalent hydrocarbyl moiety;
   D is a substituted element of Group 15 or Group 16 of the periodic system, preferably an N(R₂₇)₂ or OR₂₇ moiety, in which R₂₇ is selected to be an alkyl moiety, an aryl moiety, or an aralkyl moiety, preferably R27 is a methyl moiety;
   Y is an element selected from Group 15 of the periodic system, preferably N
   M is a transition metal, preferably selected from Group 3 or 4 of the periodic system, more preferably selected from Ti, Hf and Zr;
   X is a sigma-bonded ligand, preferably selected from a halogen, an alkyl moiety, an aralkyl moiety, an alkoxy moiety, an aryloxy moiety, and a dialkylamine moiety; and
n is the amount of X ligands bonded to X.
a co-catalyst selected from the group: MAO, DMAO, MMAO, SMAO or ammonium salts or trityl salts of fluorinated tetraarylborates, preferably MAO, MMAO, trityl tetrakis(pentafluorophenyl)borate dimethylanilinium or tri(alkyl)ammonium tetrakis (pentafluorophenyl)borate and
optionally, a scavenger selected from the group: trimethyl aluminum, triethyl aluminum, triisobutyl aluminum, trihexyl aluminum, trioctyl aluminum and
optionally, a chain transfer agent selected from the group: dihydrogen or AlR¹⁰₃, BR¹⁰₃ or MgR¹⁰₂ or ZnR¹⁰₂, where each R¹⁰ is independently selected from hydrogen or hydrocarbyl.
b) A deprotection step where the product obtained by step a) is treated with water or a Brønsted acid or base solution, capable to abstract the residue derived from the protecting agent from the protected functionalized olefin copolymer to obtain the functionalized polyolefin.

In an embodiment, after the deprotection step (b), a recovery step (c) of the functionalized polyolefin is carried out by a deashing step in order to separate residues of the protective species, such as aluminum oxides and hydroxides, from the functionalized polyolefin.

In an embodiment, the at least one olefin monomer is selected from the group consisting of ethylene, propylene, 1-butene, 3-methyl-1-butene, 1-pentene, 4-methyl-1-pentene, 1-hexene, vinyl cyclohexane, 1-octene, norbornene, vinylidene-norbornene, ethylidene-norbornene, or wherein the at least one olefin monomer is propylene and/or 1-hexene.

In an embodiment, the at least one the functionalized olefin monomers is selected from the group comprising: allyl alcohol, 3-buten-1-ol, 3-buten-2-ol, 3-buten-1,2-diol, 5-hexene-1-ol, 5-hexene-1,2-diol, 7-octen-1-ol, 7-octen-1,2-diol, 9-decen-1-ol, 10-undecene-1-ol, 5-norbornene-2-methanol, 3-butenoic acid, 4-pentenoic acid, 10-undecenoic acid, 5-norbornene-2-carboxylic acid, 5-norbornene-2-acetic acid, 5-hexen-1-thiol, 10-undecen-1-thiol, N-propyl-5-hexen-1-amine, N-isopropyl-5-hexen-1-amine and N-cyclohexyl-5-hexen-1-amine, 4-penten-2-amine, 3-methyl-4-penten-2-amine, 3-butene-1-thiol, 5-hexene-1-thiol, preferably 3-buten-1-ol, 5-hexene-1-ol, 5-norbornene-2-methanol, 3-butenoic acid, 4-pentenoic acid, 5-norbornene-2-carboxylic acid.

In an embodiment, the protection step is performed by reacting a functionalized olefin monomer with an aluminum trialkyl, where the aluminum trialkyl is selected from the group comprising: triethyl aluminum, triisobutyl aluminum, trihexyl aluminum, trioctyl aluminum, or with a dialkyl aluminum alkoxide, R¹¹OAl(R¹²)₂ where R¹¹=methyl, ethyl, n-propyl, isopropyl, n-butyl, isobutyl, tert-butyl, cyclohexyl and R¹²=ethyl, isobutyl, n-hexyl, n-octyl.

In an embodiment, the amount of the functionalized olefin monomers in the functionalized polyolefin obtained from step b) is from 0.01 to 20 mol %, preferably from 0.02 to 15 mol % or from 0.05 to 10 mol %, or from 0.1 to 5 mol %, more preferably 0.02-2 mol %, with respect to the total molar amount of the olefin monomers and the functionalized olefin monomers in the functionalized polyolefin.

In an embodiment, a first and a second olefin monomer are used to be copolymerized with the at least one protected functionalized olefin monomer, wherein the first and second olefin monomer are different and wherein the amount of the first olefin monomer is from 20 to 80 mol % and the amount of second olefin monomer is from 80 to 20 mol %, based on the total molar amount of first and second olefin monomer.

In an embodiment, at least one of the olefin monomers is propylene used in an amount of at least 50 wt %, preferably at least 60 wt %, more preferably at least >70 wt %, most preferably at least 80 wt % with respect to the total weight of the olefin monomers and the functionalized olefin monomers.

In an embodiment, the first olefin is propylene or ethylene and the second olefin is 1-hexene, 1-octene or norbornene, or the first olefin is propylene and the second olefin is ethylene.

In an embodiment the deprotection step is carried out with water.

In an embodiment the deprotection step is carried out with a Brønsted acid, preferably HCl.

In an embodiment the deprotection step is carried out with a base, preferably Brønsted base, more preferably NaOH.

In an embodiment a deashing step can be performed after the deprotection step.

In an embodiment a functionalized copolymer is obtained, preferably a copolymer in which the first monomer is selected from the group comprising ethylene and propylene and the second monomer is selected from the group comprising 3-buten-1-ol, 5-hexen-1-ol and 5-norbornene-2-methanol, more preferably the functionalized copolymer is poly(propylene-co-5-hexen-1-ol), poly(ethylene-co-5-hexen-1-ol), poly(propylene-co-3-buten-1-ol), poly(ethylene-co-3-buten-1-ol) or poly(ethylene-co-5-norbornene-2-methanol).

In an embodiment a functionalized terpolymer is obtained, preferably a terpolymer in which the first monomer is selected from the group comprising ethylene and propylene, the second monomer is selected from the group comprising propylene, 1-hexene, 1-octene and norbornene and the third monomer is selected from the group comprising 3-buten-1-ol, 5-hexen-1-ol and 5-norbornene-2-methanol, more preferably the functionalized terpolymer is poly(propylene-co-ethylene-co-5-hexen-1-ol), poly(propylene-co-1-hexene-co-5-hexen-1-ol), poly(ethylene-co-norbornene-co-5-hexen-1-ol), poly(ethylene-co-1-octene-co-5-hexen-1-ol), poly(propylene-co-ethylene-co-3-buten-1-ol), poly(propylene-co-1-hexene-co-3-buten-1-ol), poly(ethylene-co-1-octene-co-3-buten-1-ol), poly(ethylene-co-norbornene-co-3-buten-1-ol) or poly(ethylene-co-norbornene-co-5-norbornene-2-methanol).

A second aspect of the invention is the use of a functionalized polyolefin obtained by a process according to the invention in an article, compatibilizer or adhesive, adhesion improver in coating or paint.

A third aspect of the invention is the use of functionalized polyolefin obtained by a process according to the invention in a foam article in which the aluminum species such as aluminum oxide hydroxide has not been separated from the functionalized polyolefin.

A forth aspect of the invention is the use, in a solution process, of a catalyst system comprising a hafnium or zirconium complex supported by a dianionic tri- and/or tetra-dentate ligand and a co-catalyst selected from the group: MAO, DMAO, MMAO, SMAO and ammonium salts or trityl salts of fluorated tetraarylborates, in order to obtain a hydroxyl, carboxylic acid, amine or thiol functionalized polyolefin, preferably a hydroxyl, carboxylic acid or amine functionalized polyolefin, more preferably a hydroxyl or carboxylic acid functionalized polyolefin, even more preferably hydroxyl functionalized polyolefin.

Finally a last aspect of the invention is a functionalized olefin obtainable by the process of the invention preferably a functionalized olefin copolymer having:
M_{w} range 10 to 300 kg/mol
Mₙ range of 5 to 150 kg/mol
Crystallinity>30%
Melting point between 100-155° C.
Randomly distributed hydroxyl, carboxylic acid, amine or thiol functionalities, preferably carboxylic acid, amine or thiol functionalities,
A functional comonomer content of 0.05-10 mol %, preferably 0.1-5 mol %, more preferably 0.02-2 mol %

Or a Functionalized olefin terpolymer having:
M_{w} range 10 to 300 kg/mol
Mₙ range 5 to 150 kg/mol
Crystallinity range 0-30%
Melting point between 40-120° C.
A comonomer content of 0.5-20 mol %, preferably 2-18 mol %, more preferably 5-15 mol %
Randomly distributed hydroxyl, carboxylic acid, amine or thiol functionalities, preferably carboxylic acid, amine or thiol functionalities,
A functional comonomer content of 0.05-10 mol %, preferably 0.1-5 mol %, more preferably 0.02-2 mol %

In an embodiment, the functionalized olefin comprises at least 0.1 more preferably at least 0.5 wt % and maximum 5 wt % of aluminum elements.

### DETAILED DESCRIPTION

The process for solution copolymerization to obtain a functionalized polyolefin according to the invention comprises at least the two following steps in which:

### Step a)

A copolymerization step of at least one olefin monomer and at least one protected functionalized olefin monomer in the presence of the following components:

### Olefin Monomer

The olefin monomer is selected from the group comprising: ethylene, propylene, 1-butene, 3-methyl-1-butene, 1-pentene, 4-methyl-1-pentene, 1-hexene, vinyl cyclohexane, 1-octene, norbornene, vinylidene-norbornene, ethylidene-norbornene, or a combination of therefore.

In another embodiment the at least one olefin monomer is propylene, in particular in an amount of at least 50 wt %, preferably at least 60 wt %, more preferably at least >70 wt %, most preferably at least 80 wt % with respect to the total weight of the olefin monomers and the functionalized olefin monomers.

In another embodiment the at least one olefin monomer is ethylene, in particular in an amount of at least 50 wt %, preferably at least 60 wt %, more preferably at least >70 wt %, most preferably at least 80 wt % with respect to the total weight of the olefin monomers and the functionalized olefin monomers.

The polymerization step may use one type of olefin monomer or two or more types of olefin monomer.

In another embodiment, the first and second olefin monomer are different and the amount of the first olefin monomer is from 20 to 80 mol % and the amount of second olefin monomer is from 80 to 20 mol %, based on the total molar amount of first and second olefin monomer.

In another embodiment, the first olefin is ethylene and the second olefin is 1-octene.

In another embodiment, the first olefin is ethylene and the second olefin is norbornene.

In another embodiment, the first olefin is propylene and the second olefin is 1-hexene.

In another embodiment, the first olefin is propylene and the second olefin is ethylene.

### Protected Functionalized Olefin Monomer

The protected functionalized olefin monomer has the following structure according to Formula (III) or (IIIbis)

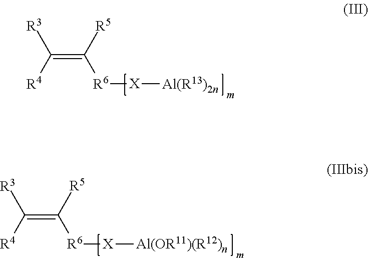

wherein R³, R⁴, and R⁵ are each independently selected from the group consisting of H and hydrocarbyl with 1 to 16 carbon atoms,
wherein n is 1 or 2,
when n=1, X is selected from —O—, —S— or —CO₂— and R⁷ is H, or
when n=2, X is N and

Wherein R¹¹=methyl, ethyl, n-propyl, isopropyl, n-butyl, isobutyl, tert-butyl, cyclohexyl,
R¹²=ethyl, isobutyl, n-hexyl, n-octyl, and
R¹³=Hydrogen, methyl, ethyl, n-propyl, isopropyl, n-butyl, isobutyl, tert-butyl, cyclohexyl,

Wherein m is an entire number between 1 and 10, preferably 1 or 2, and is a reaction product of:
a functionalized olefin monomer according to Formula (I)

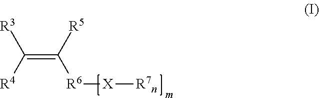

wherein R³, R⁴, and R⁵ are each independently selected from the group consisting of H and hydrocarbyl with 1 to 16 carbon atoms,
wherein R⁶—[X—(R⁷)ₙ]ₘ is a polar functional group containing m heteroatom-containing functionalities X—(R⁷)ₙ, in which m is an entire number between 1 and 10, preferably 1 or 2,
wherein
   when n=1, X is selected from —O—, —S— or —CO₂— and R⁷ is H, or
   when n=2, X is N and at least one R⁷ is H and the other R⁷ is selected from the group consisting of H and a hydrocarbyl group with 1 to 16 carbon atoms,
wherein R⁶ is either —C(R⁸)(R⁹)— or a plurality of —C(R⁸)(R⁹)— groups, wherein R⁸, and R⁹ are each independently selected from the group consisting of H or hydrocarbyl with 1 to 16 carbon atoms and R⁶ comprises 1 to 10 carbon atoms,
wherein X is attached to either the main chain and/or side chain of R⁶,
wherein R⁴ and R⁶ may together form a ring structure that is functionalized with one or multiple X—(R⁷)ₙ.

Preferably, X is selected from —O— or —CO₂—.

and
a protecting agent according to one of the Formula (II) or (II bis)

AlR¹³₃ (II)
where R¹³=Hydrogen, methyl, ethyl, n-propyl, isopropyl, n-butyl, isobutyl, tert-butyl, cyclohexyl,

R¹¹OAl(R¹²)₂ (IIbis)
where R¹¹=methyl, ethyl, n-propyl, isopropyl, n-butyl, isobutyl, tert-butyl, cyclohexyl and R¹²=ethyl, isobutyl, n-hexyl, n-octyl
during a protection step.

In a preferred embodiment, the functionalized olefin monomer according to Formula I is a hydroxyl- or carboxylic acid-bearing α-olefin or hydroxyl- or carboxylic acid-functionalized ring-strained cyclic olefin monomer, preferably a hydroxyl, a dihydroxyl or carboxylic acid α-olefin monomer.

Hydroxyl-bearing functionalized α-olefin monomers may correspond for example to Formula I wherein R³, R⁴ and R⁵ are each H and wherein X is —O— and wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms. Examples of R⁶ groups are —(CH₂)₉— and —(CH₂)₄—.

Further examples of the hydroxyl-functionalized α-olefin monomer include, but are not limited to allyl alcohol, 3-buten-1-ol, 3-buten-2-ol, 3-buten-1,2-diol, 5-hexene-1-ol, 5-hexene-1,2-diol, 7-octen-1-ol, 7-octen-1,2-diol, 9-decen-1-ol, 10-undecene-1-ol, preferably 3-buten-1-ol, 5-hexene-1-ol.

Even further examples of functionalized olefin monomer include hydroxyl-functionalized ring-strained cyclic olefins (also called internal olefins), which may be for example typically hydroxyl-functionalized norbornenes, preferably 5-norbornene-2-methanol. They correspond to Formula I wherein R³ and R⁵ are H and R⁴ and R⁶ together for a ring structure that is functionalized with X—H, wherein X is —O—.

Carboxylic acid-bearing functionalized olefin monomers may for example correspond to Formula I wherein R³ and R⁵ are each H and wherein X is —CO₂— and wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms. An example of an R⁶ group is —(CH₂)₈—. Preferred acid functionalized olefin monomers may be selected from the group of 3-butenoic acid, 4-pentenoic acid, 5-norbornene-2-carboxylic acid.

Thiol-bearing functionalized olefin monomers may for example correspond to Formula I wherein R³ and R⁵ are each H and wherein X is —S— and wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms. Examples of R⁶ groups are —(CH₂)₉— and —(CH₂)₄—. Preferred thiol functionalized olefin monomers may be selected from the group of 5-hexen-1-thiol, 10-undecen-1-thiol.

Amine-bearing functionalized olefin monomers may for example correspond to Formula I wherein R³ and R⁵ are each H and wherein X is —N(H)R⁷— and wherein R⁶ is either —C(R⁸)(R⁹)— or a plurality of —C(R⁸)(R⁹)— groups, wherein R⁸, and R⁹ are each independently selected from the group consisting of H or hydrocarbyl with 1 to 16 carbon atoms and wherein R⁷ is H or hydrocarbyl. An examples of an R⁶ group is —(CH₂)₄—. Preferred amine functionalized olefin monomers may be selected from the group of N-methyl-5-hexen-1-amine, N-ethyl-5-hexen-1-amine, N-propyl-5-hexen-1-amine, N-isopropyl-5-hexen-1-amine, N-cyclohexyl-5-hexen-1-amine.

In an embodiment 2 different monomers are used in order to obtain a copolymer, preferably a copolymer in which the first monomer is selected in the group comprising ethylene and propylene and the second monomer is selected from the group comprising 3-buten-1-ol, 5-hexen-1-ol and 5-norbornene-2-methanol, more preferably the functionalized copolymer is poly(propylene-co-5-hexen-1-ol), poly(ethylene-co-5-hexen-1-ol), poly(propylene-co-3-buten-1-ol), poly(ethylene-co-3-buten-1-ol) or poly(ethylene-co-5-norbornene-2-methanol).

In another embodiment 3 different monomers are used in order to obtain a terpolymer, preferably a terpolymer in which the first monomer is selected in the group comprising ethylene and propylene, the second monomer is selected in the group comprising propylene, 1-hexene, 1-octene and norbornene and the third monomer is selected in the group comprising 3-buten-1-ol, 5-hexen-1-ol and 5-norbornene-2-methanol, more preferably the functionalized terpolymer is poly(propylene-co-ethylene-co-5-hexen-1-ol), poly(propylene-co-1-hexene-co-5-hexen-1-ol), poly(ethylene-co-norbornene-co-5-hexen-1-ol), poly(ethylene-co-1-octene-co-5-hexen-1-ol), poly(propylene-co-ethylene-co-3-buten-1-ol), poly(propylene-co-1-hexene-co-3-buten-1-ol), poly(ethylene-co-1-octene-co-3-buten-1-ol), poly(ethylene-co-norbornene-co-3-buten-1-ol) or poly(ethylene-co-norbornene-co-5-norbornene-2-methanol).

It is preferred that the amount of the functionalized olefin monomers in the functionalized polyolefin obtained from step b) is from 0.01 to 20 mol %, preferably from 0.02 to 15 mol % or from 0.05 to 10 mol %, or from 0.1 to 5 mol %, more preferably 0.02 to 2 mol %, with respect to the total molar amount of the olefin monomers and the functionalized olefin monomers in the functionalized polyolefin.

### Protecting Agent

The hydrogen atoms directly bound to X in the functionalized olefin monomer has a Brønsted acidic nature poisonous to the highly reactive catalyst. A protecting agent is used, which can react with the acidic hydrogen and binds to the monomer comprising the polar group. This reaction will prevent a reaction of the acidic polar group (—X—H) with the catalyst and coordination of the polar group (—X—) to the catalyst.

Examples of protecting agents are silyl halides, trialkyl aluminum complexes, dialkyl aluminum alkoxide complexes, dialkyl magnesium complexes, dialkyl zinc complexes or trialkyl boron complexes.

In the process of the invention it is preferred that the protecting agent is selected from trialkyl aluminum complexes selected from the group comprising: triethyl aluminum, triisobutyl aluminum, trihexyl aluminum, trioctyl aluminum, or with a dialkyl aluminum alkoxide, R¹¹OAl(R¹²)₂ where R¹¹=methyl, ethyl, n-propyl, isopropyl, n-butyl, isobutyl, tert-butyl, cyclohexyl and R¹²=ethyl, isobutyl, n-hexyl, n-octyl, or a combination of a trialkyl aluminum and a dialkyl aluminum alkoxide. The most preferred masking agent is triethyl aluminum.

Preferably, the protecting agent is according to one of the Formula (II) or (IIbis)

AlR¹³₃ (II)

where R¹³=Hydrogen, methyl, ethyl, n-propyl, isopropyl, n-butyl, isobutyl, tert-butyl, cyclohexyl,

R¹¹OAl(R¹²)₂ (IIbis)

where R¹¹=methyl, ethyl, n-propyl, isopropyl, n-butyl, isobutyl, tert-butyl, cyclohexyl and R¹²=ethyl, isobutyl, n-hexyl, n-octyl

Surprisingly, triethyl aluminum does not lead to severe chain transfer and does not inhibit the catalyst comprising the ligand-metal complex as describe above. This feature allows to use triethyl aluminum instead of triisobutyl aluminum, which is a great cost benefit.

In order to obtain the protected functionalized olefin monomer, a preliminary protection step is performed prior to the copolymerization step of the functionalized olefin monomer.

In an embodiment, the protection step in order to obtain a protected functionalized olefin monomer according to Formula (I) may be performed by an alumination reaction of a hydroxyl or carboxylic acid functionalized olefin monomer by reacting it a trialkyl aluminum, for example triethyl aluminum, or a dialkyl aluminum alkoxide, for example diethyl aluminum ethoxide, or the combination of a trialkyl aluminum and dialkyl aluminum alkoxide, for example triethyl aluminum and diethyl aluminum ethoxide.

The molar amount of the protecting agent preferably is at least the same molar amount as the functional group in the functionalized olefin monomer. Preferably, the molar amount of protecting agent is at least 10 mol % higher than the amount of functionalized olefin monomer, or at least 20 mol % higher. Typically the amount of protecting agent is less than 250 mol % of functionalized olefin monomer. In some occasions higher amounts may be used or may be necessary.

### Catalyst System Suitable for the Process According to the Invention.

The process according to the invention is performed in the presence of a suitable catalyst system which comprise at least:
A catalyst
A co-catalyst
Optionally a scavenger
Optionally a chain transfer

### Catalyst

The catalyst is a ligand-metal complex having a bridged bis-aryl structure of which one aryl group is bi-aryl. In particular, the ligands are dianionic, tri and/or tetra-dentate chelating ligands that can occupy up to four coordination sites of a metal precursor atom and more specifically have a bridged-bis-aryl structure. The metal-bis-phenolate based ligand complexes used in this invention can be characterized by the general formula:

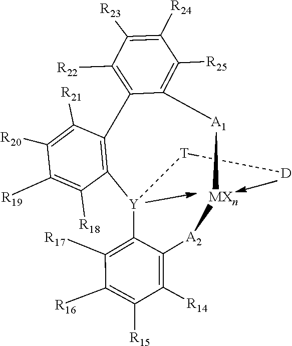

### Wherein

each of R₁₄ to R₂₅ may individually be a moiety selected from hydrogen, an aryl 5 moiety, an aryl moiety, a halogen, an alkyl or aryl moiety with halogen substituent(s), an alkoxy moiety, a siloxy moiety, or a nitrogen-containing moiety, wherein each R moiety may optionally form a ring structure with an adjacent R moiety;
each of A₁ and A₂ may individually be a moiety selected from:
   an element of Group 16 of the periodic system; and
   a moiety containing an element of Group 15 of the periodic system;
preferably wherein A₁ and A₂ are selected from O or NR₂₆, wherein R₂₆ is an alkyl, aryl or aralkyl moiety, preferably a substituted or unsubstituted phenyl moiety, preferably a p-tolyl moiety
T is a divalent hydrocarbyl moiety;
D is a substituted element of Group 15 or Group 16 of the periodic system, preferably an N(R₂₇)₂ or OR₂₇ moiety, in which R₂₇ is selected to be an alkyl moiety, an aryl moiety, or an aralkyl moiety, preferably R27 is a methyl moiety;
Y is an element selected from Group 15 of the periodic system, preferably N
M is a transition metal, preferably selected from Group 3 or 4 of the periodic system, more preferably selected from Ti, Hf and Zr;
X is a sigma-bonded ligand, preferably selected from a halogen, an alkyl moiety, an aralkyl moiety, an alkoxy moiety, an aryloxy moiety, and a dialkylamine moiety; and
n is the amount of X ligands bonded to X.

In preferable embodiments, each of R₁₄ and R₂₅ are individually selected to be a moiety selected from t-butyl, adamantyl, 9H-carbazole-9-yl, hydrogen, and phenyl. For example, R14 and R25 may be the same, or R₁₄ and R₂₅ may be different.

It is preferred that each of R₁₆ and R₂₃ are individually selected to be a moiety selected from hydrogen, t-butyl and methyl, preferably wherein R₁₆ and R₂₃ are the same or wherein R₁₆ and R₂₃ are different. Furthermore, it is preferred that each of R₁₅, R₁₇, R₁₈, R₁₉, R₂₀, R₂₁, R₂₂ and R₂₄ are hydrogen.

In certain preferable embodiments, T is selected from an ethyl moiety (—CH₂—CH₂—) and an n-propyl moiety (—CH₂—CH₂—CH₂—); particularly preferably, T is an n-propyl moiety. Further, it is preferred that Y is nitrogen.

In certain embodiments of the invention, D may be part of a cyclic structure like pyridyl, tetrahydrofuran, or furane.

In some embodiment the hafnium or zirconium or titanium complex supported by a dianionic tri- and/or tetra-dentate ligand is selected from the group: 2′-((3-(9H-carbazol-9-yl)-2-olato-5-methylphenyl)(3-methoxypropyl)amino)-3-(9H-carbazol-9-yl)-5-methyl-[1,1′-biphenyl]-2-olato] dimethyl hafnium; 2′-((3-(9H-carbazol-9-yl)-2-olato-5-methylphenyl)(3-methoxypropyl)amino)-3-(9H-carbazol-9-yl)-5-methyl-[1,1′-biphenyl]-2-olato]dimethyl zirconium; [2′-((3-(9H-carbazol-9-yl)-2-olato-5-methylphenyl)(3-methoxypropyl)amino)-3-(adamantan-1-yl)-5-methyl-[1,1′-biphenyl]-2-olato] dimethyl hafnium; [2′-((3-(9H-carbazol-9-yl)-2-olato-5-methylphenyl)(3-methoxypropyl)amino)-3-(adamantan-1-yl)-5-methyl-[1,1′-biphenyl]-2-olato] dimethyl zirconium; [2′-((3-(adamantan-1-yl)-2-olato-5-methylphenyl)(3-methoxypropyl)amino)-3-(9H-carbazol-9-yl)-5-methyl-[1,1′-biphenyl]-2-olato]dimethyl zirconium; [2′-((3-(adamantan-1-yl)-2-olato-5-methylphenyl)(3-methoxypropyl)amino)-3-(9H-carbazol-9-yl)-5-methyl-[1,1′-biphenyl]-2-olato] dimethyl hafnium; [2′-((3-(adamantan-1-yl)-2-olato-5-methylphenyl)(2-methoxyethyl)amino)-3-(9H-carbazol-9-yl)-5-methyl-[1,1′-biphenyl]-2-olato] dimethyl zirconium; [2′-((3-(adamantan-1-yl)-2-olato-5-methylphenyl)(2-methoxyethyl)amino)-3-(9H-carbazol-9-yl)-5-methyl-[1,1′-biphenyl]-2-olato] dimethyl hafnium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato] dibenzyl zirconium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato] dibenzyl zirconium; [3-(tert-butyl)-2′-((3-(tert-butyl)-2-hydroxy-5-methylphenyl)(3-methoxypropyl)amino)-5-methyl-[1,1′-biphenyl]-2-olato] dibenzyl zirconium; [3-(tert-butyl)-2′-((3-(tert-butyl)-2-hydroxy-5-methylphenyl)(3-methoxypropyl)amino)-5-methyl-[1,1′-biphenyl]-2-olato] dibenzylhafnium; [3-(tert-butyl)-2′-((3-(tert-butyl)-2-hydroxy-5-methylphenyl)(3-methoxypropyl)amino)-5-methyl-[1,1′-biphenyl]-2-olato] dimethyl hafnium; [3-(tert-butyl)-2′-((3-(tert-butyl)-2-hydroxy-5-methylphenyl)(3-methoxypropyl)amino)-5-methyl-[1,1′-biphenyl]-2-olato] dimethyl zirconium; [3-(tert-butyl)-2′-((3-methoxypropyl)(5-methyl-2-(p-tolylamino)phenyl)amino)-5-methyl-[1,1′-biphenyl]-2-olato]dimethyl hafnium; [3-(tert-butyl)-2′-((3-methoxypropyl)(5-methyl-2-(p-tolylamino)phenyl)amino)-5-methyl-[1,1′-biphenyl]-2-olato] dimethyl zirconium; [3-(tert-butyl)-2′-((2-methoxyethyl)(2-((4-methoxyphenyl)amino)-5-methylphenyl)amino)-5-methyl-[1,1′-biphenyl]-2-olato] dimethyl hafnium; [3-(tert-butyl)-2′-((2-methoxyethyl)(2-((4-methoxyphenyl)amino)-5-methylphenyl)amino)-5-methyl-[1,1′-biphenyl]-2-olato] dimethyl zirconium; [3-(tert-butyl)-2′-((2-methoxyethyl)(5-methyl-2-(p-tolylamino)phenyl)amino)-5-methyl-[1,1′-biphenyl]-2-olato] dimethyl hafnium; [3-(tert-butyl)-2′-((2-methoxyethyl)(5-methyl-2-(p-tolylamino)phenyl)amino)-5-methyl-[1,1′-biphenyl]-2-olato] dimethyl zirconium; [3-(tert-butyl)-2′-((2-methoxyethyl)(5-isopropyl-2-(p-tolylamino)phenyl)amino)-5-methyl-[1,1′-biphenyl]-2-olato] dimethyl hafnium; [3-(tert-butyl)-2′-((2-methoxyethyl)(5-isopropyl-2-(p-tolylamino)phenyl)amino)-5-methyl-[1,1′-biphenyl]-2-olato] dimethyl zirconium; [3-(tert-butyl)-2′-((3-(tert-butyl)-2-hydroxy-5-methylphenyl)(3-methoxypropyl)amino)-5-methyl-[1,1′-biphenyl]-2-olato] dimethyl hafnium; [3-(tert-butyl)-2′-((3-(tert-butyl)-2-hydroxy-5-methylphenyl)(3-methoxypropyl)amino)-5-methyl-[1,1′-biphenyl]-2-olato] dimethyl zirconium; [25: 3-(tert-butyl)-2′-((3-(tert-butyl)-2-hydroxy-5-methylphenyl)(3-methoxypropyl)amino)-5-methyl-[1,1′-biphenyl]-2-olato] dichloro titanium; [3-(tert-butyl)-2′-((3-(tert-butyl)-2-hydroxy-5-methylphenyl)(2-methoxyethyl)amino)-5-methyl-[1,1′-biphenyl]-2-olato] monochloro dimethylamido titanium; [3-(tert-butyl)-2′-((3-(tert-butyl)-2-hydroxy-5-methylphenyl)(2-methoxyethyl)amino)-5-methyl-[1,1′-biphenyl]-2-olato] dichloro titanium; [3-(tert-butyl)-2′-((3-(tert-butyl)-2-hydroxy-5-methylphenyl)(2-methoxyethyl)amino)-5-methyl-[1,1′-biphenyl]-2-olato] dimethyl zirconium; [3-(tert-butyl)-2′-((3-(tert-butyl)-2-hydroxy-5-methylphenyl)(2-methoxyethyl)amino)-5-methyl-[1,1′-biphenyl]-2-olato] dimethyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato] dibenzyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato] dimethyl hafnium; [2′-((3-(9H-carbazol-9-yl)-2-hydroxy-5-methylphenyl)(2-(dimethylamino)ethyl)amino)-3-(tert-butyl)-5-methyl-[1,1′-biphenyl]-2-olato] dimethyl zirconium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato] dibenzyl hafnium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato] dimethyl hafnium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato] dibenzyl zirconium; [2′-((3-(9H-carbazol-9-yl)-2-hydroxy-5-methylphenyl)(2-methoxyethyl)amino)-3-(tert-butyl)-5-methyl-[1,1′-biphenyl]-2-olato] dimethyl zirconium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato] dibenzyl hafnium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato] dimethyl hafnium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato] dibenzyl zirconium; [2′-((3-(9H-carbazol-9-yl)-2-hydroxy-5-methylphenyl)(2-methoxyethyl)amino)-3-(9H-carbazol-9-yl)-5-methyl-[1,1′-biphenyl]-2-olato] dimethyl zirconium; [3-((1s,3s)-adamantan-1-yl)-2′-((3-((3r,5r,7r)-adamantan-1-yl)-2-hydroxy-5-methylphenyl)(2-methoxyethyl)amino)-5-methyl-[1,1′-biphenyl]-2-olato] dimethyl hafnium; [3-((1s,3s)-adamantan-1-yl)-2′-((3-((3r,5r,7r)-adamantan-1-yl)-2-hydroxy-5-methylphenyl)(2-methoxyethyl)amino)-5-methyl-[1,1′-biphenyl]-2-olato] dimethyl zirconium; [6,6′-(((2-methoxyethyl)azanediyl)bis(methylene))bis(2,4-di-tert-butylphenolato) dibenzyl hafnium; [6,6′-(((2-methoxyethyl)azanediyl)bis(methylene))bis(2,4-di-tert-butylphenolato) dibenzyl zirconium; [2-(tert-butyl)-6-((3-methoxypropyl)(2′-(p-tolylamino)-[1,1′-biphenyl]-2-yl)amino)-4-methylphenolato] dimethyl hafnium; [3-(tert-butyl)-2′-((3-(tert-butyl)-2-hydroxy-5-methylphenyl)(3-phenoxypropyl)amino)-5-methyl-[1,1′-biphenyl]-2-olato]dimethyl hafnium; [3-(tert-butyl)-2′-((3-(tert-butyl)-2-hydroxy-5-methoxyphenyl)(3-methoxypropyl)amino)-5-methyl-[1,1′-biphenyl]-2-olato] dimethyl zirconium; [3-(tert-butyl)-2′-((3-(tert-butyl)-2-hydroxy-5-(trifluoromethyl)phenyl)(3-methoxypropyl)amino)-5-methyl-[1,1′-biphenyl]-2-olato] dibenzyl zirconium; [3-(tert-butyl)-2′-((3-(tert-butyl)-2-hydroxy-5-methylphenyl)(3-(phenylthio)propyl)amino)-5-methyl-[1,1′-biphenyl]-2-olato] dimethylhafnium; →[3-(tert-butyl)-2′-((3-(tert-butyl)-2-hydroxy-5-methylphenyl)(3-(phenylthio)propyl)amino)-5-methyl-[1,1′-biphenyl]-2-olato] dimethyl zirconium; [3-(tert-butyl)-2′-((3-methoxypropyl)(5-methyl-2-(p-tolylamino)phenyl)amino)-5-methyl-[1,1′-biphenyl]-2-olato] dichloro titanium; 3-(tert-butyl)-2′-((2-methoxyethyl)(5-methyl-2-(p-tolylamino)phenyl)amino)-5-methyl-[1,1′-biphenyl]-2-olato] dichloro titanium; [3″,5″-di-tert-butyl-2-((3-(tert-butyl)-2-hydroxy-5-methylphenyl)(3-methoxypropyl)amino)-5′-methyl-[1,1′:3′,1″-terphenyl]-2′-olato] dimethyl hafnium; 3-(tert-butyl)-2′-((3-(tert-butyl)-2-hydroxy-5-methylphenyl)(2-ethoxyethyl)amino)-5-methyl-[1,1′-biphenyl]-2-olato] dichloro titanium; 3-(tert-butyl)-2′-(butyl(3-(tert-butyl)-2-hydroxy-5-methylphenyl)amino)-5-methyl-[1,1′-biphenyl]-2-olato]dibenzyl hafnium; 3-(tert-butyl)-2′-(butyl(3-(tert-butyl)-2-hydroxy-5-methylphenyl)amino)-5-methyl-[1,1′-biphenyl]-2-olato] dibenzyl zirconium; [2″-((3-(tert-butyl)-2-hydroxy-5-methylphenyl)(3-methoxypropyl)amino)-2,4,5′,6-tetramethyl-[1,1′:3′,1″-terphenyl]-2′-olato] dimethyl zirconium; [3-(tert-butyl)-2′-((3-(tert-butyl)-2-hydroxy-5-methylphenyl)(3-(dimethylamino)propyl)amino)-[1,1′-biphenyl]-2-olato] dibenzyl zirconium; [N2-(3-methoxypropyl)-N2-(5-methyl-2-(p-tolylamino)phenyl)-N2′-(p-tolyl)-[1,1′-biphenyl]-2,2′-diamino] dichloro hafnium; [N2-(3-methoxypropyl)-N2-(5-methyl-2-(p-tolylamino)phenyl)-N2′-(p-tolyl)-[1,1′-biphenyl]-2,2′-diamino] dichloro zirconium; [N2-(3-methoxypropyl)-N2-(5-methyl-2-(p-tolylamino)phenyl)-N2′-(p-tolyl)-[1,1′-biphenyl]-2,2′-diamino] dimethyl hafnium; [N2-(3-methoxypropyl)-N2-(5-methyl-2-(p-tolylamino)phenyl)-N2′-(p-tolyl)-[1,1′-biphenyl]-2,2′-diamino] dimethyl zirconium; 3-(tert-butyl)-2′-((3-(tert-butyl)-2-hydroxy-5-methylphenyl)(3-(dimethylamino)propyl)amino)-5-methyl-[1,1′-biphenyl]-2-olato] dichloro titanium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato]dichloro titanium; [2′-((3-((3r,5r,7r)-adamantan-1-yl)-2-hydroxy-5-methylphenyl)(3-methoxypropyl)amino)-3-(tert-butyl)-5-methyl-[1,1′-biphenyl]-2-olato] dimethyl hafnium; [3-(tert-butyl)-2′-((3-(tert-butyl)-2-hydroxy-5-methylphenyl)(4-methoxybutyl)amino)-5-methyl-[1,1′-biphenyl]-2-olato] dimethyl hafnium; [3-(tert-butyl)-2′-((3-(tert-butyl)-2-hydroxy-5-methylphenyl)(4-methoxybutyl)amino)-5-methyl-[1,1′-biphenyl]-2-olato] dimethyl zirconium; [3-(tert-butyl)-2′-((3-(tert-butyl)-2-hydroxy-5-methylphenyl)(3-ethoxypropyl)amino)-5-methyl-[1,1′-biphenyl]-2-olato] dimethyl zirconium; [3-(tert-butyl)-2′-((3-(tert-butyl)-2-hydroxy-5-methylphenyl)(3-ethoxypropyl)amino)-5-methyl-[1,1′-biphenyl]-2-olato] dichloro titanium; [2″-((3-(tert-butyl)-2-hydroxy-5-methylphenyl)(3-methoxypropyl)amino)-2,4,5′,6-tetramethyl-[1,1′:3′,1″-terphenyl]-2′-olato] dimethyl hafnium; [3-((1S,3s)-adamantan-1-yl)-2′-((3-(tert-butyl)-2-hydroxy-5-methylphenyl)(3-methoxypropyl)amino)-5-methyl-[1,1′-biphenyl]-2-olato]dimethyl hafnium; [3-((1S,3s)-adamantan-1-yl)-2′-((3-(tert-butyl)-2-hydroxy-5-methylphenyl)(3-methoxypropyl)amino)-5-methyl-[1,1′-biphenyl]-2-olato] dimethyl zirconium; [2-(tert-butyl)-6-((2′-(isopropylamino)-5′-methyl-[1,1′-biphenyl]-2-yl)(3-methoxypropyl)amino)-4-methylphenolato] dibenzyl hafnium; [2-(tert-butyl)-6-((2′-(isopropylamino)-5′-methyl-[1,1′-biphenyl]-2-yl)(3-methoxypropyl)amino)-4-methylphenolato] dibenzyl zirconium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato] dimethyl hafnium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato] dimethyl zirconium; [2′-((3-(tert-butyl)-2-hydroxy-5-methylphenyl)(3-methoxypropyl)amino)-5-methyl-3-(2-phenylpropan-2-yl)-[1,1′-biphenyl]-2-olato] dimethyl zirconium.

In a particular embodiment of the invention:
D is O(CH3) or N(CH3)2;
T is ethyl or n-propyl;
Y is N;
A1 is O or N(p-tolyl), preferably 0; and
A2 is O or N(p-tolyl).

### Co-Catalyst

The co-catalyst is selected from the group: MAO, DMAO, MMAO, SMAO or ammonium salts or trityl salts of fluorinated tetraarylborates, preferably MAO, MMAO, trityl tetrakis(pentafluorophenyl)borate dimethylanilinium or tri(alkyl)ammonium tetrakis (pentafluorophenyl)borate such as tri(n-butyl)ammonium tetrakis(pentafluorophenyl)borate, methyl di(alkyl)ammonium tetrakis(pentafluorophenyl)borate. More examples can be found in the review articles of Bochmann Organometallics 2010, 29, 4711-4740 and Chen and Marks Chem. Rev. 2000, 100, 1391-1434.

Methylaluminoxane or MAO as used in the present description may mean: a compound derived from the partial hydrolysis of trimethyl aluminum that serves as a co-catalyst for catalytic olefin polymerization.

Supported methylaluminoxane or SMAO as used in the present description may mean: a methylaluminoxane bound to a solid support.

Depleted methylaluminoxane or DMAO as used in the present description may mean: a methylaluminoxane from which the free trimethyl aluminum has been removed.

Modified methylaluminoxane or MMAO as used in the present description may mean: modified methylaluminoxane, viz. the product obtained after partial hydrolysis of trimethyl aluminum plus another trialkyl aluminum such as tri(isobutyl) aluminum or tri-n-octyl aluminum.

Fluorinated aryl borates as used in the present description may mean: a borate compound having four fluorinated (preferably perfluorinated) aryl ligands.

### Optional Scavenger

A scavenger can optionally be added to the catalyst system in order to react with impurities that are present in the polymerization reactor, and/or in the solvent and/or monomer feed. This scavenger prevents poisoning of the catalyst during the olefin polymerization process. The optional scavenger is selected from the group: trimethyl aluminum, triethyl aluminum, triisobutyl aluminum, trihexyl aluminum, trioctyl aluminum, preferably triethyl aluminum.

Surprisingly, triethyl aluminum does not lead to severe chain transfer and does not inhibit the catalyst comprising the ligand-metal complex as describe above. This feature allows to use triethyl aluminum instead of triisobutyl aluminum, which is a great cost benefit.

### Optional Chain Transfer Agent

Optional chain transfer agent is selected from the group: dihydrogen or AlR¹⁰₃, BR¹⁰₃ or ZnR¹⁰₂, where each R¹⁰ is independently selected from hydrogen or hydrocarbyl.

### Polymerization Conditions

The polymerization according to the invention is performed in a solution process using a catalyst system as described above.

In the process, the polymerization conditions, like for example temperature, time, pressure, monomer concentration can be chosen within wide limits. The polymerization temperature is in the range from 100 to 250° C., preferably 110 to 210° C., more preferably 130 to 180° C. The polymerization time is in the range of from 10 seconds to 20 hours, preferably from 1 minute to 2 hours, preferably 2 minutes to 1 hour, more preferably 5 to 30 minutes. The molecular weight of the polymer can be controlled by use of hydrogen or other chain transfer agents. The polymerization may be conducted by a batch process, a semi-continuous process or a continuous process and may also be conducted in two or more steps of different polymerization conditions. The polyolefin produced is separated from the polymerization solvent and dried by methods known to a person skilled in the art.

In an embodiment, a hindered phenol, such as for example butylated hydroxytoluene (BHT), may be added during the polymerization process, especially for example in an amount between 0.1 and 5 mol. equivalents of main group metal compound(s), used as scavenger, co-catalyst and/or masking agent. This may contribute to increase molecular weight and/or comonomer incorporation.

Preferably, the amount of the functionalized olefin monomers in step a) is from 0.01 to 20 mol %, preferably from 0.02 to 15 mol % or from 0.05 to 10 mol %, or from 0.1 to 5 mol %, more preferably 0.02 to 2 mol %, with respect to the total molar amount of the olefin monomers and the functionalized olefin monomers.

The invention may involve a further addition of other additives such as a processing stabilizer (primary antioxidant) such as Irganox 1010.

### Step b)

Following the polymerization step a), a deprotection step b) is performed where the product obtained by step a) is treated to abstract the residue derived from the protecting agent from the protected functionalized olefin copolymer to obtain the functionalized polyolefin.

In an embodiment, the protected functionalized olefin copolymer is treated with a Brønsted acid, preferably HCl.

In another embodiment, the protected functionalized olefin copolymer is treated with a base solution, preferably Brønsted base, more preferably NaOH.

In another embodiment, the protected functionalized olefin copolymer is treated with water.

In order to prevent the corrosion of the polymerization reactor, the deprotection step may be carried out in a tank coated with PE, PTFE or PFA, and the base material is stainless steel when a base is used or carbon steel when an acid is used.

Optionally, a deashing step may be performed after the deprotection step in order to separate the aluminum species such as aluminum oxides and hydroxides, for example Al(O)OH, Al(OH)₃ and Al₂O₃, insoluble in water from the polymer by flocculation and settling, filtration including membrane separation, centrifugal separation, or adsorption.

However, such deashing step may be skipped in particular when the functionalized polyolefin obtained by a process according to the invention is used in a foam article. In this embodiment, the aluminum species such as aluminum oxide hydroxide will help to create the foam.

Optionally, a neutralization step may be performed on the aqueous phase containing the aluminum species such as aluminum oxide hydroxide with a sodium hydroxide solution when an acid is used during the deprotection step, and with sulfuric acid solution or CO₂ gas when a base is used during the deprotection step.

It is noted that the invention relates to all possible combinations of features described herein, preferred in particular are those combinations of features that are present in the claims. It is in particular noted that the preferred materials or preferred amounts of materials as disclosed in the context of the process according to the invention equally apply to the functionalized olefin copolymer and/or the functionalized olefin copolymer composition.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

### Examples

The invention is now elucidated by way of the following non-limiting examples.

The following examples are not limiting examples and have been realized with the following monomers: propylene (C₃), 1-hexene (C₆) and 5-hexen-1-ol (C₆═OH). However, other monomer could be use in order to achieve the present invention.

### Synthesis of hydroxyl-functionalized propylene copolymer, poly(propylene-co-5-hexen-1-ol) (poly(C₃-co-C₆OH))

The polymerization experiment was carried out using a stainless steel BUCHI reactor (2 L) filled with pentamethylheptane (PMH) solvent (1 L) using a stirring speed of 600 rpm. For entry 2, Table 1, catalyst and comonomer solutions were prepared in a glove box under an inert dry nitrogen atmosphere. The reactor was heated to 40° C. followed by the addition of TEA (1.0 M solution in toluene, 2 mL) and triethylaluminum (TEA)-pacified 5-hexen-1-ol (1.0 M solution in toluene, TEA:5-hexen-1-ol (mol ratio)=1, 20 mL, 20 mM). The reactor was charged with gaseous propylene (100 g, 2.38 mol) and heated to the desired polymerization temperature of 130° C. resulting in a partial propylene pressure of 15 bar. Once the set temperature was reached, the polymerization reaction was initiated by the injection of the catalyst precursor [3-(tert-butyl)-2′-((3-(tert-butyl)-2-hydroxy-5-methylphenyl)(3-methoxypropyl)amino)-5-methyl-[1,1′-biphenyl]-2-olato] dimethyl zirconium [CAS 2728681-69-2] (1.6 μmol) premixed with MAO (30 wt % solution in toluene, 4.5 mmol):BHT (2:1 ratio). The reaction was stopped by pouring the polymer solution into a container flask containing demineralized water/iPrOH (50 wt %, 1 L) and Irganox 1010 (1.0 M, 2 mmol). The collected product was dried at 80° C. in a vacuum oven, prior to the addition of Irganox 1010 as an antioxidant.

Synthesis of hydroxyl-functionalized propylene terpolymer, poly(propylene-co-1-hexene-co-5-hexen-1-ol) (poly(C₃-co-C₆-co-C₆OH)). The polymerization experiment was carried out using a stainless steel BUCHI reactor (2 L) filled with pentamethylheptane (PMH) solvent (1 L) using a stirring speed of 600 rpm. For entry 2, Table 2, catalyst and comonomer solutions were prepared in a glove box under an inert dry nitrogen atmosphere. The reactor was heated to 40° C. followed by the addition of TEA (1.0 M solution in toluene, 2 mL), 1-hexene (neat 10 mL, 81 mM), and triethylaluminum (TEA)-pacified 5-hexen-1-ol (1.0 M solution in toluene, TEA:5-hexen-1-ol (mol ratio)=1, 20 mL, 20 mM). The reactor was charged with gaseous propylene (100 g, 2.38 mol) and heated to the desired polymerization temperature of 130° C. resulting in a partial propylene pressure of about 15 bar. Once the set temperature was reached, the polymerization reaction was initiated by the injection of the catalyst precursor [3-(tert-butyl)-2′-((3-(tert-butyl)-2-hydroxy-5-methylphenyl)(3-methoxypropyl)amino)-5-methyl-[1,1′-biphenyl]-2-olato] dimethyl zirconium [CAS 2728681-69-2](^{tBu}ONOO—Zr(Me)₂, 1.6 μmol) premixed with MAO (30 wt % solution in toluene, 4.5 mmol):BHT (2:1 ratio). The reaction was stopped by pouring the polymer solution into a container flask containing demineralized water/iPrOH (50 wt %, 1 L) and Irganox 1010 (1.0 M, 2 mmol). The collected product was dried at 80° C. in a vacuum oven, prior to the addition of Irganox 1010 as an antioxidant.

TABLE 1
Results of propylene-TEA—C₆^{═}OH copolymerization at 130° C.

| | | | | | | | | Al |
|---|---|---|---|---|---|---|---|---|
| | | | Co-monomer | Yield | Mₙ | | Co-momoner | content |
| Ref | Cat. system | Co-monomer | (mM) | (g) | (kg/mol) | Ð | (mol %) | (wt %) |
| 1 | ^{tBu}ONOO- | n.a. | n.a. | 6.5 | 22.2 | 2.9 | n.a. | n.d. |
| | Zr/MAO/ | | | | | | | |
| | BHT | | | | | | | |
| 2 | ^{tBu}ONOO- | C6OH/ | 20 | 5.3 | 23.3 | 3.3 | 0.25 | 1.1 |
| | Zr/MAO/ | TEA | | | | | | |
| | BHT | | | | | | | |
| 3 | ^{tBu}ONOO- | C6OH/ | 20 | 7.7 | 63.3 | 3.0 | 0.33 | n.d. |
| | Zr/TTB | TEA | | | | | | |

Conditions:
Reactions performed in a 2 L BÜCHI reactor, propylene partial pressure at 40° C. = 5 bar (100 g of propylene), and 15 bar at 130° C., reaction time = 30 minutes, cat. ^{tBu}ONOO-Zr = 1.6 μmol premixed with MAO (30 wt % solution in toluene, 4.5 mM; MAO:BHT (2:1 ratio) (entries 1-2) or premixed with [Ph₃C⁺][B(C₆F₅)₄⁻]:TiBA (TTB)/TiBA [TTB:TiBA:Cat] = 5:250:1 (entry 3), pentamethylheptane = 1 L, additional amount of TEA (1.0M solution in toluene, 2 mL) was added as scavenger. TEA-passivated 5-hexen-1-ol (mol ratio TEA: 5-hexen-1-ol = 1). The yield determined using the weight of the polymer obtained after drying in a vacuum oven overnight at 80° C. Mn and Ð determined by HT-SEC in oDCB at 150° C. Co-momoner content determined by ¹H NMR.

TABLE 2
Results of propylene terpolymerization with 1-hexene and TEA—C₆^{═}OH at 130° C.

| | | C₆^{═} | TEA— | | | | C6 | C6OH | Al |
|---|---|---|---|---|---|---|---|---|---|
| | | feed | C₆^{═}OH | Yield | Mₙ | | content | content | content |
| Ref. | Cat. system | (mM) | (mM) | (g) | (kg/mol) | Ð | (% mol) | (% mol) | (wt %) |
| 1 | tBuONOO- | 81 | n.a. | 6.2 | 31.1 | 2.6 | 3.2 | n.a. | n.d. |
| | Zr/MAO/ | | | | | | | | |
| | BHT | | | | | | | | |
| 2 | tBuONOO- | 81 | 20 | 5.6 | 23.3 | 2.8 | 4.6 | 0.12 | 0.3 |
| | Zr/MAO/ | | | | | | | | |
| | BHT | | | | | | | | |
| 3 | tBuONOO- | 81 | 10 | 9.4 | 36.1 | 3.1 | 4.1 | 0.19 | n.d. |
| | Zr/TTB | | | | | | | | |

Conditions:
Reactions performed in a 2 L BÜCHI reactor, propylene partial pressure at 40° C. = 5 bar (100 g of propylene), and 15 bar at 130° C., reaction time = 30 minutes, cat. ^{tBu}ONOO-Zr(Me)₂ = 1.6 μmol, MAO (30 wt % solution in toluene) = 4.5 mM; MAO:BHT (2:1 ratio) (entries 1-2) or [Ph₃C⁺][B(C₆F₅)₄⁻]:TiBA (TTB)/TiBA [TTB:TiBA:Cat] = 5:250:1, pentamethylheptane = 1 L, additional amount of TEA (1.0M solution in toluene, 2 mL) was added as scavenger. TEA-passivated 5-hexen-1-ol (mol ratio TEA: 5-hexen-1-ol = 1). The yield determined using the weight of polymer obtained after drying in a vacuum oven overnight at 80° C. Mn, and Ð determined by HT-SEC in oDCB at 150° C. The content of C₆OH and C₆ determined by ¹H and ¹³C NMR, respectively.

### ¹H NMR Characterization

The percentage of functionalization was determined by ¹H NMR analysis carried out at 130° C. using deuterated tetrachloroethane (TCE-D2) as solvent and recorded in 5 mm tubes on a Varian Mercury spectrometer operating at a frequency of 400 MHz. Chemical shifts are reported in ppm versus tetramethylsilane and were determined by reference to the residual solvent protons.

### High Temperature Size Exclusion Chromatography (HT-SEC)

The molecular weights, reported in kg-mol⁻¹, and the PDI were determined by means of high temperature size exclusion chromatography, which was performed at 150° C. in a GPC-IR instrument equipped with an IR4 detector and a carbonyl sensor (PolymerChar, Valencia, Spain). Column set: three Polymer Laboratories 13 μm PLgel Olexis, 300×7.5 mm. 1,2-Dichlorobenzene (o-DCB) was used as eluent at a flow rate of 1 mL·min⁻¹. The molecular weights and the corresponding PDIs were calculated from HT SEC analysis with respect to narrow polystyrene standards (PSS, Mainz, Germany).

### Differential Scanning Calorimetry (DSC)

Thermal analysis was carried out on a DSC Q100 from TA Instruments at a heating rate of 5° C.·min⁻¹. First and second runs were recorded after cooling down to ca. −40° C. All copolymers were found to be amorphous as determined by DSC.

### Inductively Coupled Plasma Mass Spectrometry Analysis (ICP-MS)

The aluminium content (wt. %) was determined using ICP-MS: 100-200 mg of sample is digested in 6 mL concentrated nitric acid (trace metal grade) by microwave assisted acid digestion using an Anton Paar Multiwave PRO equipped with closed high pressure Quartz digestion vessels. After the microwave digestion run, the acid is analytically transferred into a pre-cleaned plastic centrifuge tube containing 1 mL of internal standard solution and is diluted with Milli-Q water up to the 50 mL mark. The aluminum in the samples is quantified using multi-element calibration standards from Inorganic Ventures. The aluminum is detected and measured using an Agilent 8900 ICP-MS system by measuring the aluminum at the 27 m/z Isotope in (High Energy) Helium Collision mode.

1. A process for solution copolymerization to obtain a functionalized polyolefin comprising at least the following steps:
a) a copolymerization step of copolymerizing at least one olefin monomer and at least one protected functionalized olefin monomer in the presence of a catalyst system, wherein the olefin monomer is represented by CHR¹=CHR², wherein R¹ and R² are each independently chosen from hydrogen or a hydrocarbyl group having 1 to 6 carbon atoms, wherein the protected functionalized olefin monomer is a reaction product of a functionalized olefin monomer and a protecting agent during a protection step and the functionalized olefin monomer is represented by the structure according to Formula (I): 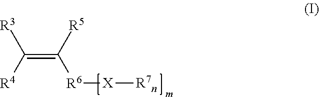
wherein R³, R⁴, and R⁵ are each independently selected from the group consisting of H and hydrocarbyl with 1 to 16 carbon atoms,
wherein R⁶—[X—(R⁷)ₙ]ₘ is a polar functional group containing m heteroatom-containing functionalities X—(R⁷)ₙ, in which m is an integer between 1 and 10, X is an atom or group of atom selected from the list —O—, —S—, CO₂—, an —N— and, n is an integer of 1 or 2 wherein
when n is 1, X is selected from —O—, —S— or —CO₂— and R⁷ is H, or
when n is 2, X is N and at least one R⁷ is H and the other R⁷ is selected from the group consisting of H and a hydrocarbyl group with 1 to 16 carbon atoms,
wherein R⁶ is either —C(R⁸)(R⁹)— or a plurality of —C(R⁸)(R⁹)— groups, wherein R⁸ and R⁹ are each independently selected from the group consisting of H or hydrocarbyl with 1 to 16 carbon atoms and R⁶ comprises 1 to 10 carbon atoms,
wherein X is attached to either the main chain and/or side chain of R⁶,
wherein R⁴ and R⁶ may together form a ring structure that is functionalized with one or multiple X—(R⁷)ₙ,
and wherein the catalyst system comprises:
metal-bis-phenolate based ligand complexes used in this invention can be characterized by the general formula: 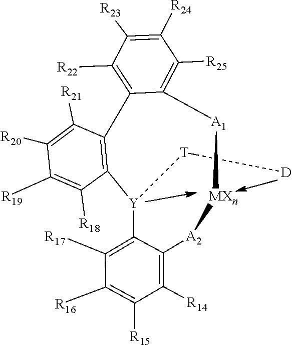
wherein
each of R₁₄ to R₂₅ may individually be a moiety selected from hydrogen, an aryl 5 moiety, an aryl moiety, a halogen, an alkyl or aryl moiety with halogen substituent(s), an alkoxy moiety, a siloxy moiety, or a nitrogen-containing moiety, wherein each R moiety may optionally form a ring structure with an adjacent R moiety;
each of A₁ and A₂ may individually be a moiety selected from:
an element of Group 16 of the periodic system; and
a moiety containing an element of Group 15 of the periodic system;
T is a divalent hydrocarbyl moiety;
D is a substituted element of Group 15 or Group 16 of the periodic system;
Y is an element selected from Group 15 of the periodic system;
M is a transition metal;
X is a sigma-bonded ligand; and n is the amount of X ligands bonded to X,
a co-catalyst selected from the group: MAO, DMAO, MMAO, SMAO or ammonium salts or trityl salts of fluorinated tetraarylborates, and
optionally, a chain transfer agent selected from the group: dihydrogen or AlR¹⁰₃, BR¹⁰₃ or ZnR¹⁰₂, where each R¹⁰ is independently selected from hydrogen or hydrocarbyl,
b) a deprotection step where the product obtained by step a) is treated with water or a Brønsted acid or base solution, capable to abstract the residue derived from the protecting agent from the protected functionalized olefin copolymer to obtain the functionalized polyolefin.

2. The process according to claim 1, wherein after the deprotection step (b), a recovery step (c) of the functionalized polyolefin is carried out by a deashing in order to separate residues of the protective species such as aluminum oxides and hydroxides, from the functionalized polyolefin.

3. The process according to claim 1, wherein the at least one olefin monomer is selected from ethylene, propylene, 1-butene, 3-methyl-1-butene, 1-pentene, 4-methyl-1-pentene, 1-hexene, vinyl cyclohexane, 1-octene, norbornene, vinylidene-norbornene, or ethylidene-norbornene, or wherein the at least one olefin monomer is propylene and/or 1-hexene.

4. The process according to claim 1, wherein the at least one the functionalized olefin monomers is selected from allyl alcohol, 3-buten-1-ol, 3-buten-2-ol, 3-buten-1,2-diol, 5-hexene-1-ol, 5-hexene-1,2-diol, 7-octen-1-ol, 7-octen-1,2-diol, 9-decen-1-ol, 10-undecene-1-ol, 5-norbornene-2-methanol, 3-butenoic acid, 4-pentenoic acid, 10-undecenoic acid, 5-norbornene-2-carboxylic acid, 5-norbornene-2-acetic acid, 5-hexen-1-thiol, 10-undecen-1-thiol, N-propyl-5-hexen-1-amine, N-isopropyl-5-hexen-1-amine and N-cyclohexyl-5-hexen-1-amine, 4-penten-2-amine, 3-methyl-4-penten-2-amine, 3-butene-1-thiol, or 5-hexene-1-thiol.

5. The process according to claim 1, wherein the protection step is performed by reacting a functionalized olefin monomer with an aluminum trialkyl, where the aluminum trialkyl is selected from triethyl aluminum, triisobutyl aluminum, trihexyl aluminum, trioctyl aluminum, or with a dialkyl aluminum alkoxide, or R¹¹OAl(R¹²)₂ where R¹¹=methyl, ethyl, n-propyl, isopropyl, n-butyl, isobutyl, tert-butyl, cyclohexyl and R¹²=ethyl, isobutyl, n-hexyl, n-octyl.

6. The process according to claim 1, wherein the amount of the functionalized olefin monomers in the functionalized polyolefin obtained from step b) is from 0.01 to 20 mol %, with respect to the total molar amount of the olefin monomers and the functionalized olefin monomers in the functionalized polyolefin.

7. The process according to claim 1 wherein a first and a second olefin monomer are used to be copolymerized with the at least one protected functionalized olefin monomer, wherein the first and second olefin monomer are different and wherein the amount of the first olefin monomer is from 20 to 80 mol % and the amount of second olefin monomer is from 80 to 20 mol %, based on the total molar amount of first and second olefin monomer.

8. The process according to claim 1 wherein at least one of the olefin monomers is propylene used in an amount of at least 50 wt %, with respect to the total weight of the olefin monomers and the functionalized olefin monomers.

9. The process according to claim 1 wherein at least one of the olefin monomers is ethylene used in an amount of at least 50 wt %, with respect to the total weight of the olefin monomers and the functionalized olefin monomers.

10. The process according to claim 7, wherein the first olefin is propylene or ethylene and the second olefin is 1-hexene, 1-octene or norbornene, or the first olefin is propylene and the second olefin is ethylene.

11. The process according to claim 2, wherein the deprotection step is carried out with water.

12. The process according to claim 2, wherein the deprotection step is carried out with a Brønsted acid.

13. The process According to claim 2, wherein the deprotection step is carried out with a base.

14. The process according to claim 11, wherein a deashing step is performed after the deprotection step.

15. The process according to claim 1, wherein a functionalized terpolymer is obtained.

16. A functionalized olefin polymer obtainable by the process of claim 1.

17. A functionalized olefin copolymer having:
a. M_{w} range 10 to 300 kg/mol determine by High Temperature Size Exclusion Chromatography (HT-SEC) according to the description
b. Mₙ range of 5 to 150 kg/mol determine by High Temperature Size Exclusion Chromatography (HT-SEC) according to the description
c. randomly distributed carboxylic acid, amine or thiol functionalities
d. a functional comonomer content of 0.05-10 mol %, and an olefin comonomer selected ethylene, propylene, 1-butene, 3-methyl-1-butene, 1-pentene, 4-methyl-1-pentene, 1 hexene, vinyl cyclohexane, 1-octene, norbornene, vinylidene-norbornene, or ethylidene-norbornene.

18. The functionalized olefin terpolymer of claim 17 having:
a. M_{w} range 10 to 300 kg/mol determine by High Temperature Size Exclusion Chromatography (HT-SEC) according to the description
b. Mₙ range 5 to 150 kg/mol determine by High Temperature Size Exclusion Chromatography (HT-SEC) according to the description
c. crystallinity range 0-30%, determine by Differential scanning calorimetry (DSC) according to the description
d. melting point between 40-120° C.
e. randomly distributed carboxylic acid, amine or thiol functionalities
f. a first olefin comonomer selected from the ethylene, propylene, 1-butene, 3-methyl-1-butene, 1-pentene, 4-methyl-1-pentene, 1 hexene, vinyl cyclohexane, 1-octene, norbornene, vinylidene-norbornene, or ethylidene-norbornene, a second comonomer different of the first olefin comonomer and selected from ethylene, propylene, 1-butene, 3-methyl-1-butene, 1-pentene, 4-methyl-1-pentene, 1-hexene, vinyl cyclohexane, 1-octene, norbornene, vinylidene-norbornene, or ethylidene-norbornene, and having a content of 0.5-20 mol %, and a functional third comonomer content of 0.05-10 mol %.

19. The functionalized olefin polymer composition according to claim 16 wherein the composition comprises at least 0.1 and maximum 5 wt % of aluminum elements.

20. (canceled)

21. The process of claim 1, further comprising foaming the functionalized polyolefin obtained by a process according to claim 1 in which the aluminum species has not been separated from the functionalized polyolefin.

22. (canceled)
